(19) United States
(12) Patent Application Publication
(10) Pub. No.: US 2005/0130676 A1
(43) Pub. Date: Jun. 16, 2005

(54) Methods, systems, and media for acquiring ratings for points of interest

(75) Inventors: Scott Broussard, Cedar Park, TX (US); Ying Liu, Austin, TX (US); Eduardo Spring, Round Rock, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/733,879

(22) Filed: Dec. 11, 2003

(51) Int. Cl. H04Q 7/20

(52) U.S. Cl. 455/456.6

(57) ABSTRACT

Methods, systems, and media for acquiring ratings for points of interest associated with a particular location are disclosed. Embodiments include hardware and/or software for receiving from a user at a current location a request for rating information related to a particular location, receiving differential information, determining the current location, determining the particular location based on the current location and the differential information, transmitting the particular location to a wireless network to request the rating information, receiving rating information related to the particular location, and displaying at least part of the rating information to a user. Embodiments may also include receiving rating information relating to a particular location, wherein the rating information includes ratings for a plurality of points of interest. In one embodiment, the ratings for a plurality of points of interest are user ratings. In a further embodiment, differential information comprises a distance between the current and particular locations.

### CROSS-REFERENCE TO RELATED APPLICATION

This application is related to U.S. patent application Ser. No. ______, entitled “METHODS, SYSTEMS, AND MEDIA FOR PROVIDING A LOCATION-BASED SERVICE FOR ANOTHER LOCATION”, attorney docket number AUS92003101 US1, filed on the same day, the disclosure of which is incorporated herein in its entirety for all purposes.

### FIELD OF INVENTION

The present invention is in the field of rating locations, establishments, or other points of interest. More particularly, the present invention relates to methods, systems, and media for providing rating information, such as user ratings, related to a particular location, such as a location selected by a user that is different than the current location of the user.

### BACKGROUND

Frequently, people need to locate a nearby business establishment, tourist destination or other point of interest. A business traveler or tourist, for example, might be visiting a new city and be looking for a restaurant or hotel within walking distance of his or her present location. Similarly, someone could come upon a restaurant that has an excessively long wait and desire to find a nearby comparable restaurant. In another example, a tourist, having visited one historical site, might desire to find other tourist sites that would be easy to visit from the present location. When faced with a plethora of choices, people generally prefer to have some sort of guidance as to which place to visit.

In addition, people in strange locations often become disoriented or lost. This problem is even more prevalent when the terrain of any area makes it more difficult to see the area around the person. For example, urban environments can be confusing, particularly if a person is in a tunnel, near large skyscrapers, etc. Rural or other environments have similar problems because of trees, landforms, etc. Moreover, many people have an inadequate sense of direction and have little idea what direction they are facing.

Currently, many people rely on printed guidebooks to find nearby restaurants, businesses, tourist sites, or other points of interest. In particular, people desire to have ratings or reviews of these points of interest. Reviews and ratings from guidebooks, however, suffer from a number of failings. Information from guidebooks is often notoriously stale and out-of-date. Guidebooks also require that a person have advance knowledge of where they are going to be so that they could acquire the appropriate guidebook. For many people, advance knowledge of where they are going to be during, say, lunch time is difficult to achieve. Another failing of these methods is that they all require the person seeking an establishment or point of interest know where they are on an incomplete and often inaccurate map. For example, to properly use a guidebook, a person must know which map in the guidebook to use—which requires knowledge of the person's present location. For the tourist or business traveler in a strange location, this information may not be readily available. Further, many guidebooks feature or favor restaurants or other establishments that advertise with the guidebook, resulting in bias and/or inaccuracies.

Many people also use information from the World Wide Web (“WWW”) if they desire to find out information about a new place. While websites—sometimes—can provide more up-to-date information than printed guidebooks, they are still subject to the same detriments as guidebooks—a person has to know where they are, there is a possibility of bias or inaccuracies, etc. In addition, information on the WWW is incomplete at best, resulting in many locations having little or no reliable information and has not generally been available to persons when they away from their home or office.

On the other hand, the use of mobile devices, such as wireless or cellular telephones, to transmit, access, and receive information has become ubiquitous. Because of the highly competitive nature of the mobile phone industry, many manufacturers or providers desire to increase the functionality of the mobile phones so as to increase their desirability in the eyes of consumers. One common method of making a mobile phone service more desirable is to deliver content to the user of the mobile phone. However, content delivered to mobile phones under current systems often lacks significant value to consumers, as it's limited in value, timeliness, and flexibility. For instance, mobile phones may have a limited ability to search and sort through information provided on the WWW but that limited ability simply exacerbates the problems related to using the WWW for obtaining information about points of interest.

Even if the available rating information was easily accessible, much of the ratings or reviews information are less than desirable because the raters do not reflect the preferences of the “average” person. Many restaurant reviews, for example, are written by professional reviewers who may have different tastes than most of the readers of the reviews. Moreover, many available ratings are impacted by whether the establishment being rated advertised with the reviewer, resulting in either a subtle bias towards that establishment or even the failure to find establishments unwilling to pay for advertising. Moreover, most reviews do not provide significant details about the point of interest and do not provide detailed reviews of detailed aspects of the operation, such as service, cost, etc.

### SUMMARY OF THE INVENTION

The problems identified above are in large part addressed by methods, systems, and media for providing rating information related to a particular location. One embodiment provides a method for providing ratings related to a location different than the current location of a user. Another embodiment provides a method for requesting rating information associated with a particular location. The method generally includes determining a current location of a user via a position-determining device; interacting with the user to determine the particular location based upon the current location, in response to an inquiry from the user about the rating information associated with the particular location, wherein the interacting comprises receiving differential information indicative of a distance between the current location and the particular location from the user; transmitting the particular location to a wireless network to request the rating information; displaying, upon receipt of the rating information from the wireless network, at least part of the rating information to the user. Alternative embodiments further comprise determining a compass direction between the current location and the particular location.

Another embodiment provides an apparatus for requesting rating information associated with a particular location. The apparatus contemplates a position determining device for determining a current location; a compass; a user interface for receiving input from a user located at the current location, wherein the user input comprises differential information indicating a distance between the current location and the particular location; a transmitter for transmitting the particular location to a wireless network to request rating information related to the particular location; a receiver for receiving from a wireless network rating information related to the particular location; and a display device to display the rating information to the user.

A further embodiment provides a machine-accessible medium containing instructions, which when executed by a machine, cause said machine to perform operations. The operations can involve determining a current location of a user via a position-determining device; interacting with the user to determine the particular location based upon the current location, in response to an inquiry from the user about the rating information associated with the particular location, wherein the interacting comprises receiving differential information indicative of a distance between the current location and the particular location from the user; transmitting the particular location to a wireless network to request the rating information; displaying, upon receipt of the rating information from the wireless network, at least part of the rating information to the user.

One embodiment provides a method for providing ratings related to a location different than the current location of a user. The method generally involves receiving a request from a user located at a current location for rating information related to a particular location, wherein the request comprises an indication of the current location; receiving differential information from the user, the differential information describing the particular location relative to the current location; determining the particular location based upon the differential information and the indication of the current location; retrieving rating information relating to the particular location; and transmitting to a user the rating information relating to the particular location.

### BRIEF DESCRIPTION OF THE DRAWINGS

Other objects and advantages of the invention will become apparent upon reading the following detailed description and upon reference to the accompanying drawings in which like references may indicate similar elements:

FIG. 1 depicts an embodiment for a system for requesting, receiving, and providing rating information;

FIG. 2 depicts a schematic view of an apparatus according to one embodiment, including a position determining system and a compass;

FIG. 3 depicts a flow chart for requesting and receiving rating information related to a particular location according to one embodiment; and

FIG. 4 depicts a flow chart for providing rating information related to a particular location according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media to provide ratings related to a location, such as a location different than the current location of a user, are contemplated. Embodiments include hardware and/or software for receiving input from a user located at a current location, including differential information indicating a distance between the current location and a second, different location, determining the current location, and determining the particular location based on the current location and the differential information. In one embodiment, the particular location is transmitted to a wireless network, and rating information related to the particular location is received from a wireless network. Some or all of the rating information related to the particular location may be displayed to the user. In an alternative embodiment, the differential information and the current location are transmitted to a wireless network instead of the particular location.

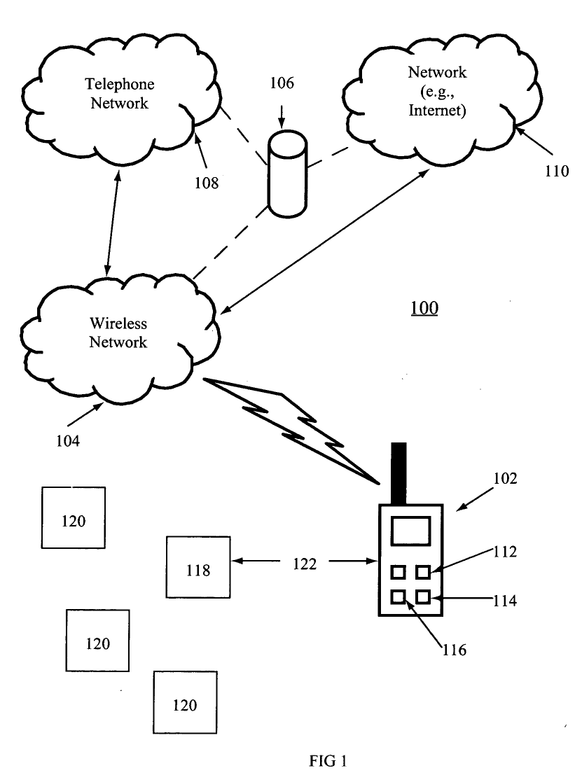

Turning now to the drawings, FIG. 1 depicts one embodiment of a system 100 for providing rating information related to a particular location. More specifically, system 100 may facilitate a user located at a current location requesting and/or receiving rating information related to a second, different location. System 100 also provides rating information related to a particular location to a user at a current location based on a request from the user. The rating information may include ratings of points of interest related to the particular location, such as ratings of points of interest in geographical proximity to the particular location, of a similar type, of a certain quality of rating, etc.

System 100 includes a wireless device 102, a wireless network 104, and a rating information system 106. System 100 also optionally includes a telephone network 108 or other network 110 in communication with wireless network 104. Wireless device 102 is a mobile communication device, such as a wireless phone, that is adapted to communicate wirelessly via a wireless network 104. In one embodiment, the wireless device 102 may communicate with a base station as part of the wireless network 104, which in turn is in communication with a mobile switching center, gateway mobile switching center (“GMSC”), or other elements of a wireless or cellular network. In one embodiment, a wireless network 104 communicates with a telephone network 108 (or other wireless or cellular networks) via a GMSC. A wireless network 104, in one embodiment, communicates with the Internet or other network 110 using the Wireless Access Protocol (“WAP”) via a WAP gateway, which translates between the protocols of the WWW and the WAP protocols of wireless devices 102.

Rating information system 106 provides rating information on multiple points of interest based on a particular location. The rating information system 106 may include a computer system, such as a server, with storage capability. In one embodiment, rating information system 106 includes a computer system such as an IBM eServer™ having one or more processors, or threads of processors, executing software and/or one or more state machines coupled with data storage devices such as random access memory (RAM), read only memory (ROM), flash memory, compact disc drives, hard drives, and the like. Software executing on the rating information system 106 may be adapted to receive and respond to a request for rating information related to a location. The rating information system 106 may communicate with wireless network 104 directly, through telephone network 108, or through another network 110, such as the Internet.

Wireless device 102 includes a position determining system 112 and a compass 114. Position determining system 112 may include hardware and/or software capable of determining the present location of the position determining system 112, and, thus, the present location of the wireless device 102. In one embodiment, position determining system 112 is a global positioning system (“GPS”) receiver integrated into the wireless device 102. In another embodiment, position determining system 112 is an add-on or aftermarket GPS receiver adapted to be connected to wireless device 102. One of ordinary skill in the art will recognize that other position determining systems such as inertial measurement units are contemplated.

Compass 114 may include hardware and/or software to determine a compass direction. In one embodiment, compass 114 is a digital compass integrated with the wireless device 102. Digital compass 114 could, in one embodiment, use an existing display of the wireless device 102 to display output. Alternatively, digital compass 114 could have a dedicated display or graphical interface or no user display at all. In another embodiment, compass 114 is a traditional magnetic compass that optionally provides output directly to the wireless device 102.

In some embodiments of system 100, if a user of a wireless device 102 desires to acquire rating information about a particular location 118, the user would point wireless device 102 in the direction of particular location 118. Compass 114 would determine the direction in which particular location 118 lies. User, in one embodiment, would input an estimated distance 122 to the particular location 118 using the user interface 116 of the wireless device 102. The current location of the wireless device 102 is calculated by the position determining system 112. When the current location, direction to the particular location 118, and estimated distance 122 to the particular location 118 are known, the particular location 118 can be calculated. The estimated distance 122 may be entered via a keypad, pull-down menus among a selection of distances, push-screen input, or any user input 116 methodology or any other fashion.

Once the particular location 118 is known, the user can then receive rating information related to that particular location 118. The ability to receive rating information about a particular location 118 provides a number of advantages. In one situation, the particular location 118 may not be physically accessible by the user, such as if there was a physical impediment to reaching the particular location (e.g., lake, cliff, mountain side, traffic blockage, etc.). Another situation might occur if a user desires information about a particular location 118 that the user is heading towards or will soon be near. In this situation, a user may see a small town across a lake and desire to know whether there are any good restaurants nearby. Another example is if a user is on a ferry and heading towards a downtown area of a city and wants to locate highly-rated service establishments, such as a gym or masseuse. Yet another example is a user in an automobile who is running out of gas or having car trouble who may desire to know of service stations located at a service station at the next exit ten miles ahead. To get rating information about a second, different location 118, a user could point a wireless device 102 towards the particular location 118, input an estimated distance 122, and receive rating information related to the particular location 118. Thus, the user having automobile trouble could point his wireless device 102 down the highway, enter an estimated distance 122 of ten miles, and receive rating information about that exit off the highway, such as the highest rated or closest service stations or repair centers. One of ordinary skill in the art will recognize that many other embodiments are contemplated.

Rating information system 106 may provide rating information related to a particular location 118. Rating information related to a particular location may include virtually any type of information about points of interest 120 that are somehow related to the particular location 118. In one example, the particular location 118 might be a corner of a city block. The rating information could be, say, ratings of restaurants within a five block radius. Each restaurant in this example would be a point of interest 120, and each would be related to the particular location 118 by being within five blocks of the particular location. When this rating information is transmitted ultimately to the user of the wireless device 102, the user could then choose a restaurant in the area of the particular location 118 based on the rating information.

Points of interest 120 may include any type of entity or establishment to be rated, such as retail stores, restaurants, companies, service stations, movie theaters, service establishments (e.g., masseuse, gyms, etc.), etc. Points of interest 120 may also include any type of location, such as tourist destinations, scenic points, historical sites, parks, etc. Areas or regions may also be points of interest 120, such as neighborhoods, park areas, etc.

Points of interest are related to the particular location 118 in some way. Geographical proximity, for example, can relate a point of interest 120 to the particular location 118. For example, related points of interest 120 could include all points of interest 120 within a certain distance (e.g., measured in linear distance, time, city blocks, etc.), within line of sight of the particular location, within a travel time of the particular location (e.g., within a five minute walk or drive, etc.), etc. Travel time from the particular location 118 may serve as an indication for estimated distance 122. Points of interest 120 can be related to the particular location 118 by the type of point of interest 120. In one embodiment, a point of interest 120 could be located at the particular location 118, and related points of interest 120 could include similar points of interest 120 to the one at the particular location 118. If an Italian restaurant is a point of interest 120 and is located at the particular location 118, for example, other nearby restaurants or Italian restaurants (or Italian/Greek restaurants) may be points of interest 120 for which rating information would be available.

In one embodiment, users of wireless devices 102 may define preferences as to which points of interest 120 would be considered related to the particular location 118. Users could specify, as one example, that only rating information about points of interest 120 within seven blocks of the particular location 118 should be retrieved. A user could exclude a type of point of interest 120 they do not prefer, such as, say, Thai restaurants. Users could also specify a preference that only rating information about points of interest 120 with a certain level of rating (e.g., four-star restaurants and above) are retrieved. One of ordinary skill the art will recognize that a user could define any type of preference for which points of interest 120 will be related.

Rating information may also include a wide variety of information about the points of interest 120. Rating information includes some type of rating of the point of interest, such as a rating by critics, users, other individuals, proprietors, the requesting user, etc. Moreover, the rating information could include any other details about the point of interest 120, such as address, phone number, universal resource locator, operating hours, description, etc. In one example, rating information about a restaurant could include operating hours and a menu, and could also include sub-ratings about particular items on the menu. Sub-ratings are ratings of particular aspects of a rated point of interest 120, and could be used for particular servers, products, menu items, service, cleanliness, price, speed of operating, etc.

When rating information about points of interest 120 is delivered to a user, the particular points of interest 120 are ranked in one embodiment. The points of interest 120, for example, could be ranked based on proximity to the particular location 118, with the closest ones being ranked higher. Ranking of points of interest can also be done based upon user preferences (e.g., user prefers Indian restaurants so they are displayed first), user or other ratings (e.g., higher ranked establishments rated higher), cost, hours/availability, overall match to the user's request, advertising or other support received from the point of interest 120, etc. One of ordinary skill in the art will recognize that any, all or none of these ranking systems and any others are possible and contemplated.

In one embodiment, rating information includes user-provided rating information about points of interest. In this embodiment, ratings of points of interest 120 are based on input provided by individuals who have visited the points of interest 120. For example, the ratings for a restaurant would include ratings from individuals who have recently dined at that restaurant. Ratings can be portrayed in any fashion, such as averages, medians, highest and lowest rating, etc. In one embodiment, greater weight can be given to some reviews, such as ratings that are more recent, from individuals with similarities to the requesting user, etc. In another embodiment, individuals may rate different aspects of a point of interest 120 (sub-ratings such as food quality and service at a restaurant) and a total rating for that point of interest 120 could take into account any or all of the sub-ratings. User-provided rating information provides a number of advantages over other types of ratings, such as those provided by critics or professional reviewers. One advantage to user-provided ratings is that they may provide a more accurate or more valuable rating to the average user of a wireless device 102. For many people, ratings by other similar people may be more valuable to them than those provided by critics or professional reviews. Another advantage is that user-provided ratings may be more up-to-date than other ratings. In one example, a user could find ratings of a restaurant from the current week or even of that night's special in trying to decide where to go for dinner. The immediacy of user-provided ratings is desirable to many people. Another potential advantage of user-provided ratings is the perceived lack of bias in those ratings. Without advertising or pressure from an employer, individuals are free to rate a point of interest 120 however they would like.

Using the user interface 116, users may input ratings for points of interest 120. In one embodiment, when a user inputs a rating, the user's current position can be determined using the position determining system 112. The nearest point of interest 120 to the user's current position can be, given the accuracy of GPS receivers, considered to be what the user is rating. In an alternative embodiment, a user could be presented a few nearby choices, from which the user would select the one for which they desire to provide a rating. The contributions of a plurality of users can be collected to provide rating information for a particular point of interest 120. Input of new ratings by a user should be made as simple as possible so as to encourage ratings.

In one embodiment, the user interface 116 should be as simple as possible. In one embodiment, the user can simply push existing buttons to fill out a form on their wireless device 102. The form, for example, could simply have options to enter differential information (such as a distance), type of point of interest 120 (such as restaurants), and an optional request button (to begin the process of requesting rating information). The form could be stored on the wireless device 102 itself, or could be delivered to the wireless device upon request via the wireless network. As bandwidth is often very important, it is usually optimal to store the form on the wireless device. As wireless devices 102 often have difficult user interfaces 116, minimizing the frequency and level of user input will likely increase user satisfaction and usage.

In one embodiment, users may be provided free or discounted wireless devices 102 in exchange for their use and input. For example, the users could be required to rate a certain number of points of interest 120 per month in order to keep their wireless device 120. This may provide a large number of motivated raters to improve the overall system 100. Businesses or other establishments could subsidize the service in this embodiment in exchange for advertising, preferential ratings (being careful to minimize any bias), etc.

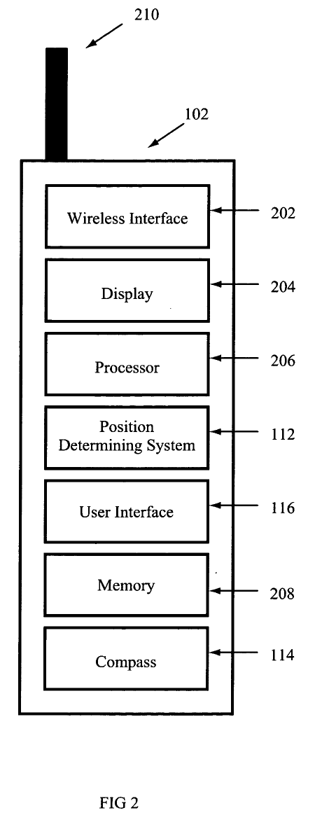

Referring now to FIG. 2, there is shown a schematic view of a wireless device 102 according to one embodiment, including a position determining system and a compass. Wireless device 102 may include a wireless interface 202, a display 204, a processor 206, a position determining system 112, a user interface 116, memory 208, a compass 114, and an antenna 210. Wireless interface 202 includes hardware and/or software to transmit and receive information from a wireless network 104. The wireless interface 202 works with optional antenna 210 to transmit and receive signals. Wireless device 102 includes a processor 206 and optional memory 208 for performing functions, storing user preferences, etc. Processor 206 may be used to perform necessary tasks for the wireless device 102, such as calculations, handling the various subsystems, etc. In some embodiments, one processor 206 is used for execution of instructions; in other embodiments, one or more processors or threads of processor(s) 206 may execute instructions. Memory 160 may include random access memory (RAM) such as double data rate (DDR) synchronous dynamic RAM (SDRAM), caches, buffers, read only memory (ROM); flash memory, and/or remote data storage like magnetic disk storage media, optical storage media, and flash memory drives.

As described in relation to FIG. 1, wireless device 102 may be any mobile communication device that is adapted to communicate wirelessly with a wireless network 104. In one embodiment, wireless device 102 is a mobile phone, but other wireless devices such as wireless-enabled pagers, personal digital assistants, an automotive-based wireless device, a Bluetooth-enabled device, etc., may also be used.

Wireless device 102 may include a display 204 and user interface 116. Display 204 may be, for example, a display screen for displaying information, such as ratings for restaurants or directions to the nearest five star restaurant, to the user. Any apparatus for conveying information to the user, such as a printer, is contemplated. User interface 116 may be any apparatus which accepts input from a user, such as buttons, dials, keys, keypad, levers, a voice recognition device, a device for accepting optical input, etc. In some embodiments, user interface 116 utilizes existing input devices, such as a mobile phone's buttons, so as to not require additional complexity.

As described in relation to FIG. 1, wireless device 102 includes a position determining device 112, such as a GPS receiver, and a compass 114, such as a digital compass. The position determining device 112 and compass 114 may be in communication with processor 206 so that processor 206 can handle directional and position information. In one embodiment, compass 114 is configured so that when a user points the wireless device 102 in the direction of a particular location 118, the compass 114 provides directional information between the user's current position and the particular location 118. For example, if the user is pointing the wireless device 102 due north, the compass 114 will indicate that the wireless device is pointing 102 due north. In one embodiment, the wireless device 102 is marked in some way so as to indicate to the user how to orient the wireless device 102 (e.g., antenna 210 pointing towards particular location 118) in order to provide the most accurate reading. Directional information, such as a compass direction, may be any information that provides an indication of a difference in direction, direction, angle of rotation, etc. between two locations or directions.

In one embodiment, a user could have a wireless device 102, such as a wireless phone, that is configured so that the user points the antenna 210 towards the particular location 118 before requesting rating information for that particular location 118. To request the rating information, the user could select, for example, a ratings button on the user interface 116. Here, a user could point the antenna 210 towards, say, a building one mile away and select the ratings button 116. The system could then request that the user enter an estimated distance to the particular location 118. Alternatively, the user could point and hold the mobile device 102 towards the particular location 118 building while entering an estimated distance 122, where entering an estimated distance serves also as the request for rating information. In this embodiment, the compass reading would be based on the reading at the moment the request was made. The user would then receive ratings information based on a particular location 118 one mile away in the direction of the antenna 210 when the request was made.

Compass 114 may optionally provide an additional benefit to the user of the wireless device 102. Compass 114 can, obviously, provide a compass direction or other directional information to the user, helping orient the user when they are located in a strange place. Moreover, compass 114, particularly if it is a digital compass, may be able to integrate with either mapping or direction software to assist the user in finding their destination. For example, if a user desires to go to another location (say, an address), software could create directions from their current location to that new location, and the compass 114 could help guide the user in the right direction.

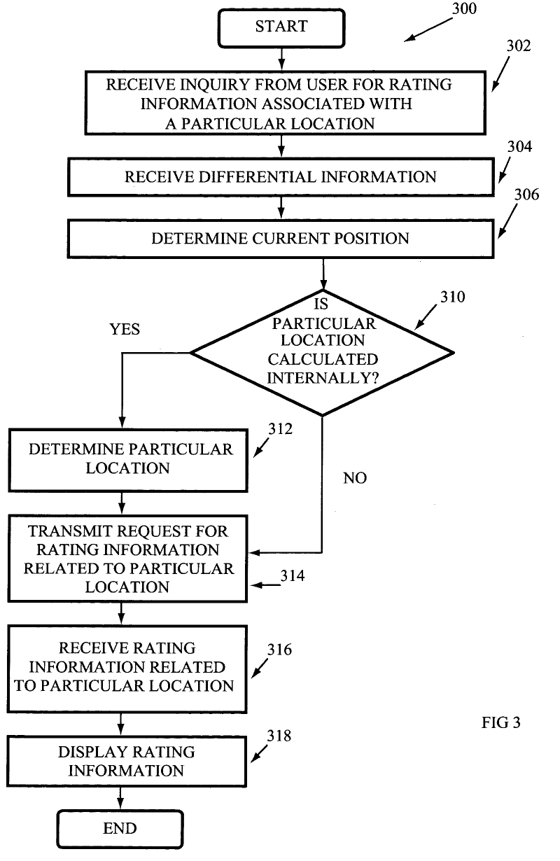

Referring now to FIG. 3, there is shown an example of a flow chart 300 for a method for requesting and receiving rating information related to a location according to one embodiment. Flow chart 300 begins with element 302, receiving a request for rating information associated with a particular location. The request for rating information may be received from a user via a user interface 116, such as via a button on the wireless device 102. A user may also optionally supply preferences for rating information, as described in more detail in relation to FIG. 1. In element 304, differential information is received from a user via a user interface 116. In one embodiment, differential information includes an estimated distance 122 between the user's current location and a particular location 118. An estimated distance could be in any type of units, such as feet, meters, miles or other distances, or other types of measurements, such as city blocks. In one alternative embodiment, input of differential information by a user is considered a request for rating information pursuant to element 302, thus performing elements 302 and 304 with one input from the user. The user may estimate distance based on any method, including guessing, use of signs or other information (e.g., road signs), or from a rangefinder. A rangefinder, such as a laser or infrared rangefinder, may be used to provide range distance to a user. In one alternative embodiment, differential information is received in element 304 directly from a rangefinder device instead of from user input.

After receiving a request for rating information, the system determines the current location in element 306. In one embodiment, the current location is determined by a position determining system 112, as described in relation to FIGS. 1 and 2. The position determining system 112 may automatically (e.g., continually) calculate the current location or it may do so upon request. For the level of accuracy needed, positions calculated by the position determining device 112 reflect the position of the wireless device 102.

Element 310 illustrates a decision block based on whether the particular location 118 is calculated internally to the wireless device 102 (e.g., via the processor 206) or external to the wireless device 102. If the particular location 118 is calculated internally, the particular location is then determined in element 312. The particular location 118 is calculated based on the current position and the differential information. A second position can be calculated, for example, if a starting location, a compass direction, and a distance along that compass direction are known. In element 314, the request for rating information related to the particular location 118 is transmitted via a wireless network 104. In one embodiment, such as when the particular location 118 is determined internally, the particular location 118 is transmitted. In another embodiment, such as when the particular location 118 is not determined internally, the current position and differential information are both transmitted so that the particular location 118 can be determined later. When the particular location 118 is not determined internally, element 312 may be skipped.

Rating information related to the particular location 118 is then received via the wireless network 104 in element 316. The rating information may include ratings or other information about points of interest 120 located near the particular location 118 or otherwise related to the particular location 118. As described in more detail in relation to FIG. 1, a wide variety of information may be included in the rating information. In element 318, the rating information is displayed to the user.

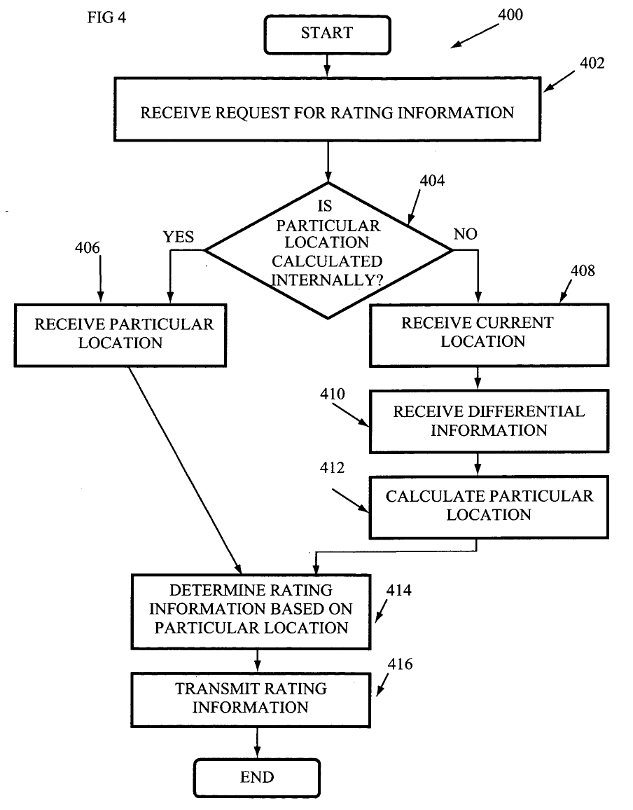

Referring now to FIG. 4, there is shown an example of a flow chart 400 for a method for providing rating information related to a particular location according to one embodiment. Flow chart 400 begins with element 402, receiving a request for rating information associated with a particular location 118. The request for rating information is typically received from a wireless device 102 via a wireless network 104. The location for which the request is made is the particular location 118. The particular location 118 may be used to determine the appropriate rating information and points of interest 120.

As flow chart 400 continues to element 404, a split occurs depending on whether the wireless device 102 determines the particular location 118 or whether it simply receives it from the wireless device 102. If the wireless device 102 determines the particular location 118, the flow chart continues to element 406, receiving the particular location 118 via the wireless network 104. If the wireless device 102 does not determine the particular location 118, the flow chart continues to element 408, receiving the current location of the requestor. After receiving the differential information in element 410, the function continues to element 412, calculating the particular location 118. The particular location 118 can be calculated, if necessary, using the current location of the requestor and the differential information.

After the particular location 118 is known (either from receiving it from the wireless device 102 or from determining it based on other information), the flowchart continues to element 414, determine rating information based on the particular location 118. This may be accomplished in a variety of ways. In several embodiments, the ratings information system 106 determines the rating information based on the particular location 118 it receives. In such embodiments, the ratings information system 106 may access a database that stores rating information. After the ratings information is determined, the ratings information is transmitted via the wireless network 104 in element 416 and flowchart 400 terminates.

One embodiment of the invention is implemented as a program product for use with a computer system such as, for example, the system 100 shown in FIG. 1. The program product could be used on a wireless device 102, on a ratings information system 106, or a combination thereof, or on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for providing rating information related to a particular location, such as a location different than the current location of a user. It is understood that the form of the invention shown and described in the detailed description and the drawings are to be taken merely as examples. It is intended that the following claims be interpreted broadly to embrace all the variations of the example embodiments disclosed.

1. A computer-implemented method for requesting rating information related to a particular location, the method comprising:
determining a current location of a user via a position-determining device;
interacting with the user to determine the particular location based upon the current location, in response to an inquiry from the user about the rating information associated with the particular location, wherein the interacting comprises receiving differential information indicative of a distance between the current location and the particular location from the user;
transmitting the particular location to a wireless network to request the rating information; and
displaying, upon receipt of the rating information from the wireless network, at least part of the rating information to the user.

2. The method of claim 1, further comprising determining a compass direction between the current location and the particular location.

3. The method of claim 1, wherein the differential information indicating a distance comprises an indication of a travel time from the current location.

4. The method of claim 3, wherein the differential information further comprises an indication of the compass direction between the current location and the particular location.

5. The method of claim 1, wherein transmitting the particular location to the wireless network comprises:
determining the particular location based on the current location and the differential information; and
transmitting the particular location to the wireless network.

6. The method of claim 1, wherein transmitting the particular location to the wireless network comprises transmitting the current location and the differential information to the wireless network.

7. The method of claim 1, wherein the rating information comprises information relating to a point of interest located near the particular location.

8. The method of claim 1, wherein the rating information comprises information relating to a plurality of points of interest related to the particular location.

9. The method of claim 1, wherein the rating information comprises user ratings for one or more points of interest related to the particular location.

10. An apparatus for requesting rating information related to a particular location, the apparatus comprising:
a position determining device for determining a current location;
a compass, wherein the compass indicates directional information between the current location and the particular location;
a user interface for receiving input from a user located at the current location, wherein the user input comprises differential information indicating a distance between the current location and the particular location;
a transmitter for transmitting the particular location to a wireless network to request rating information related to the particular location;
a receiver for receiving from a wireless network rating information related to the particular location; and
a display device to display the rating information to the user.

11. The apparatus of claim 10, further comprising a processor for determining the particular location based on the current location, directional information and the differential information.

12. The apparatus of claim 11, wherein transmitter couples with the processor to transmit the particular location as part of the request for rating information.

13. The apparatus of claim 10, wherein the transmitter is configured to transmit the particular location as part of the request for rating information.

14. The apparatus of claim 10, wherein the transmitter is configured to transmit the current location, directional information and differential information as part of the request for rating information.

15. The apparatus of claim 10, wherein the position determining device is a global positioning system receiver.

16. The apparatus of claim 10, wherein the compass is a digital compass.

17. The apparatus of claim 10, wherein the rating information comprises user ratings of one or more points of interest proximate to the second location.

18. The apparatus of claim 10, wherein the directional information comprises a compass direction between the current location and the particular location.

19. A machine-accessible medium containing instructions, which when executed by a machine, cause said machine to perform operations, comprising:
determining a current location of a user via a position-determining device;
interacting with the user to determine the particular location based upon the current location, in response to an inquiry from the user about the rating information associated with the particular location, wherein the interacting comprises receiving differential information indicative of a distance between the current location and the particular location from the user;
transmitting the particular location to a wireless network to request the rating information; and
displaying, upon receipt of the rating information from the wireless network, at least part of the rating information to the user.

20. The machine-accessible medium of claim 19, further comprising determining directional information between the current location and the particular location.

21. The machine-accessible medium of claim 19, wherein the rating information comprises user ratings for one or more points of interest proximate to the particular location.

22. A method for providing rating information using a wireless network, the method comprising:
receiving a request from a user located at a current location for rating information related to a particular location, wherein the request comprises an indication of the current location;
receiving differential information from the user, the differential information describing the particular location relative to the current location;
determining the particular location based upon the differential information and the indication of the current location;
retrieving the rating information related to the particular location; and
transmitting to the user the rating information related to the particular location.

23. The method of claim 22, wherein the rating information comprises ratings relating to a plurality of points of interest associated with the particular location.

24. The method of claim 22, wherein the rating information comprises user ratings relating to a plurality of points of interest associated with the particular location.

25. The method of claim 22, wherein receiving the request comprises receiving the request from the user via a wireless network, and wherein transmitting to the user comprises transmitting the rating information to the user via a wireless network.

26. The method of claim 22, wherein the differential information comprises an indication of the distance between the current location and the particular location.
